(19) United States
(12) Patent Application Publication
(10) Pub. No.: US 2003/0078358 A1
(43) Pub. Date: Apr. 24, 2003

(54) Polymer composition containing a semi-crystalline or glass-forming polymer in a rigid phase and, as impact modifier therein, a rubbery polymer in a dispersed phase

(75) Inventors: Edwin A.A. Van Hartingsveldt, Maastricht (NL); Roelof Marissen, Born (NL)

Correspondence Address: PILLSBURY WINTHROP, LLP, P.O. BOX 10500, MCLEAN, VA, 22102, US

(73) Assignee: DSM N.V., Heerlen (NL)

(21) Appl. No.: 10/228,260

(22) Filed: Aug. 27, 2002

Related U.S. Application Data
(63) Continuation of application No. PCT/NL01/00165, filed on Feb. 27, 2001.

(30) Foreign Application Priority Data
Feb. 28, 2000 (NL) 1014513

(51) Int. Cl. C08G 83/00

(52) U.S. Cl. 528/1

(57) ABSTRACT

The invention relates to a polymer composition containing a semi-crystalline or glass-forming polymer in a rigid phase and, as impact modifier therein, a rubbery polymer. The polymer composition according to the invention is characterized in that it has no morphological inhomogeneities with a diameter larger than 40, preferably 20 micrometer as visible on a Scanning Electron Microscopy (SEM) picture of the surface of fracture of a test bar broken in a fatigue test. As a result, the elongation at break, the fatigue resistance and the total useful service life of an object manufactured from this composition are much higher.

### CROSS REFERENCE TO RELATED APPLICATIONS

This application is a continuation of International Application No. PCT/NL01/00165, filed Feb.27, 2001, which claims priority from Dutch Application No.1014513, filed Feb. 28, 2000. These applications, in their entirety, are incorporated herein by reference.

### BACKGROUND OF THE INVENTION

The invention relates to a polymer composition containing a semi-crystalline or glass-forming polymer in a rigid phase and, as impact modifier therein, a rubbery polymer.

Such a polymer composition is known from EP-A-0.345.522. Herein polymer compositions are described that contain polycarbonate (PC) as the rigid phase and ABS (acrylonitrile-butadiene-stryrene) as impact modifier. The ABS consists for example of a SAN (styrene-acrylontrile) phase, wherein small butadiene-rubber particles with grafted SAN are dispersed. The rubber particles generally have a dimension of 0.1-10 micrometer. Here and hereinafter dimension or particle size is understood to mean average particle size. The improvement in impact properties of the PC/ABS blend is related to the presence of these rubber particles in the ABS. Such a polymer composition has a high toughness at service temperature and at low temperatures. Furthermore these materials also have a high elongation at break. These properties make this polymer composition eminently suitable for use in all kinds of, generally injection moulded, objects in applications in which very high demands are to be met, such as telephone housings, transformer housings and the like.

A disadvantage of the known polymer compositions is that objects moulded from them show crack formation at an undesirable rate, causing the useful service life to be limited to an unwanted degree.

The aim of the invention is to provide a polymer composition that does not show said disadvantage. More specifically, the aim is to improve the fatigue resistance and the elongation at break of the polymer composition.

This aim is achieved in that the polymer composition has no morphological inhomogeneities with a diameter larger than 40, preferably 20 micrometer, as visible on a Scanning Electron Microscopy (SEM) picture of the surface of fracture of a test bar broken in a fatigue test.

A fatigue test is a test in which a dumbbell-shaped test bar with a shape according to ISO R527 is subjected to a cyclic tensile load at a frequency of 1-10 Hz at a stress ratio between minimum and maximum load of 0.1 and a maximum stress of a suitably chosen percentage of the yield stress determined in a static tensile test. A suitable percentage for example is 66% for polycarbonate mixtures and 80% for polybutylene terephthalate mixtures. The service life is expressed in the number of the cyclic tensile loads (cycles) before fracture occurs in said fatigue test.

A morphological inhomogeneity is understood to be a volume part with deviating composition and a dimension that is several times larger, that is at least 2, 3 or even 4 times larger, than that of the dispersed phase. Where inhomogeneities have a shape other than globular or, during measuring, a cross-section other than circular, the equivalent diameter is used, which is the diameter of a circle with the same cross-sectional area as of the inhomogeneity on the SEM picture.

It has been found that the polymer composition according to the invention has a significantly longer useful service life, as manifested in improved fatigue resistance. The elongation at break, too, is considerably improved. The advantage thereof is that articles moulded from the polymer composition show a reduced tendency to break when subjected to considerable load during use.

The invention applies in particular to morphological inhomogeneities consisting substantially of polymer material built up from building blocks of the surrounding polymer composition but having a composition deviating from that of the surrounding polymer composition. More in particular the invention applies to morphological inhomogeneities that consist substantially of the rubbery polymer of the disperse phase.

It has been found that small quantities of relatively large morphological inhomogeneities apparently occur in these rubber-modified polymer compositions. The morphological inhomogeneities can however also be fillers, like mica and the like. For the purpose of the present invention these filler particles should also have a diameter of smaller than 40, preferably 20 micrometer. Since glass fibres are generally larger than said dimensions, the polymer composition is preferably free from glass fibres.

Many publications according to the prior art describe that the particle size of the dispersed phase should preferably be small. In CH 590897, it is described, for example, that the particle size of rubber particles in a rubber-modified polycarbonate is between 0.01 and 20, preferably between 0.06 and 10 micrometer. Herein the choice of the particle size is also described in relation to the desired mechanical properties. It is described, for example, that the particles should on the one hand preferably be small in view of the surface gloss, or on the other hand be large in view of the toughness. The inventors, however, have found that polymer compositions with particle sizes significantly smaller than 20 micrometer also contain particles having dimensions that are significantly larger than, often a multiple of, the dimensions of the particles of the dispersed phase. The inventors assume that this may be due in particular to coagulation of the rubber particles, which could occur during any stage in the process of making a rubber-modified polymer composition, for example during preparation of the rubber particles, during blending of the rubber particles with a rigid phase, such as in polycarbonate, or during injection moulding of an article from the rubber-modified polymer composition. These particles are therefore generally only present in minute quantities, and do not deteriorate most mechanical properties. Prior art publications therefore do not mention the presence of such large particles and the problem of an undesirably short useful service life.

The morphological inhomogeneities are normally almost undetectable with the usual measuring techniques because they occur in a very low concentration, for example less than approximately 100 ppm or even less than 10 ppm. Furthermore, these inhomogeneities do not affect mechanical properties of the polymer composition such as strength, impact strength and modulus. It is therefore surprising to find that morphological inhomogeneities larger than 40, in particular larger than 20 micrometer (as visible on a Scanning Electron Microscopy (SEM) picture of the surface of fracture of a test bar broken in a fatigue test) have a very adverse effect on the fatigue resistance of the polymer composition. With this method, specifically the largest inhomogeneities are found, since fracture will occur at the location of and near the largest inhomogeneities. This implies that if no particles larger than 40 micrometer occur in a fatigue fracture surface thus obtained, it is very likely that there are no particles present with a diameter larger than 40 micrometer. The fatigue resistance is very closely connected to the size of these morphological inhomogeneities. For said reasons the polymer composition according to the invention preferably contains no morphological inhomogeneities with a diameter larger than 15 micrometer, preferably 10 micrometer and even more preferably 7 micrometer.

The invention also relates to a process for the preparation of a polymer composition according to the invention, in which the polymer of the rigid phase and the rubbery polymer, which contain no morphological inhomogeneities with a diameter larger than 40, preferably 20 micrometer, are mixed. Preferably the polymer composition according to the invention is prepared using a process in which the morphological inhomogeneities with a diameter larger than 40, preferably 20 micrometer are removed from the polymer of the rigid phase and/or the rubbery polymer before, during or after the mixing thereof, preferably by filtration. It is also possible to remove the morphological inhomogeneities by filtration during injection moulding of articles. Preferably, the rubber-containing component is filtered before mixing with the rigid phase. Filtration can be performed by passing the rubber-modified polymer composition in molten form through a filter of suitable mesh size. Preferably the mesh size is between 5 and 40, more preferably between 7 and 20 micrometer. It has been found that with a mesh size of larger than 5 or preferably 7 micrometer, the loss in productivity, the increase in temperature and the thermal degradation are reduced.

The invention also relates to a polymer composition obtainable using the said processes and to moulded articles containing a polymer composition according to the invention. Such moulded articles combine very good mechanical properties such as impact strength with a very good fatigue resistance and a very high elongation at break. The polymer composition according to the invention, preferably polycarbonate modified with ABS, shows a useful service life, as determined in said fatigue test and expressed in the number of load cycles, that is at least 2, preferably at least 3, even more preferably at least 5 and most preferably at least 10 times longer that the service life of the polymer composition before removal of the morphological inhomogeinities. The invention specifically relates to a polycarbonate modified with ABS having a service life of at least 25,000, preferably at least 30,000, more preferably at least 40,000, and most preferably at least 50,000 cycles (as measured in above described fatigue test on a test bar according to ISO R527, at a load of 66% of the static tensile strength, at a frequency of 5 Hz and at a ratio between minimum and maximum load during a cycle of 0.1).

The polymer composition according to the invention can have very divergent compositions of two or more components. Preferably, the polymer in the rigid phase has been chosen from the group of polycarbonates, polyesters, polyamides, or styrene polymers and the rubbery polymer from the group of EPDM (ethylene-propylene-third monomer rubber), EP (ethylene-propylene rubber), SBR (styrene-butadiene rubber), PB (polybutadiene), MBS (methyl methacrylate butadiene styrene rubber) or acrylate rubbers.

The advantages of the invention are most evident where the rigid phase is a glass, for example polycarbonate. This polymer being very sensitive to fatigue, the improvement brought about by the measure according to the invention is very great. The rubbery polymer then preferably is polybutadiene.

The invention will now be further elucidated on the basis of the following examples.

### EXAMPLES 1-6 AND COMPARATIVE EXPERIMENTS COMPA-COMPF

ABS Ronfalin 330 was extruded on a WP 40 extruder provided with different melt filters from Fluid Dynamics (Dynalloy filter consisting of sintered ultra-thin wires (˜6 μ), Dynamesh made from woven ultra-thin wires. A filtration unit is made up of 7 candle elements with a total surface of 3900 cm². Extrusion took place at a temperature of between 220-240° C. and a screw speed of 300 rpm. The extrusion details are presented in Table 1 (T melt is the temperature of the melt, ΔP die+filter is the pressure drop across die and filter).

The resulting filtered ABS was moulded into test bars under standard conditions for ABS, at a temperature setting of 240° C. and a mould temperature of 40° C. The mechanical properties, modulus (E), tensile strength (YS) and elongation at break (EB) were determined according to standard ISO R527 at a tensile speed of 10 mm/min on 4 mm thick test bars. The notched impact strength (IM) was determined according to ISO 180/4A on 3.2 mm thick test bars. The service life, expressed in the number of cycles, was determined at a load of 65% of the static tensile strength (in this case at 65% of 43=28 MPa, a frequency of 5 Hz and a ratio between maximum and minimum load during a cycle of 0,1 (in this case the load therefore varied between 2.8 en 28 MPa). The results are listed in Table 2.

TABLE 1

| ABS | CompA | CompB | CompC | Ex1 | Ex2 | Ex3 |
|---|---|---|---|---|---|---|
| Filter medium | No filter | Dynamesh 150 | Dynamesh 74 | Dynamesh 40 | Dynaloy 25-30 | Dynaloy X5 |
| | | 150 μ | 74 μ | 40 μ | 16 μ | 7 μ |
| | | 60x60 mesh | 200x200 mesh. | 80x700 mesh | | |
| Output (kg/h) | 70 | 70 | 72 | 70 | 69 | 70 |
| T melt (° C.) | 240 | 240 | 242 | 248 | 260 | 268 |
| ΔP die + filter | ˜10 | ˜20 | ˜30 | 40-50 | 70-90 | 100-120 |
| (bar) | | | | | | |

TABLE 2

| ABS | compA | compB | CompC | Ex1 | Ex2 | Ex3 |
|---|---|---|---|---|---|---|
| E (Mpa) | 2050 | 2100 | 2060 | 2080 | 2050 | 2070 |
| YS(Mpa) | 43.0 | 43.2 | 43.0 | 43.1 | 43.0 | 43.2 |
| EB (%) | 40 ± 4 | 43 ± 9 | 56 ± 16 | 71 ± 22 | 80 ± 4 | 81 ± 3 |
| IM (kJ/m²) | 27.1 | 27.8 | 26.5 | 28.3 | 28.0 | 27.6 |
| Cycles | 1-2.10\hat{ }4 | 3-4.10\hat{ }4 | 6-8.10\hat{ }4 | 2-5.10\hat{ }5 | 8-10.10\hat{ }5 | 1-2.10\hat{ }6 |

The non-filtered ABS Ronfalin 330 (comparative experiment ABS CompA) and the ABS filtered at 16 micrometer (example ABS E×2) according to the invention were compounded under standard conditions with polycarbonate Xantar 22 (viscosity number 50), 0.2 % Irganox 1076 stabilizer en 0.3% PETS release agent. The resulting PC/ABS composition according to the invention was moulded into test bars. The mechanical properties and service life (at 66% and 75% of the static strength) of these test bars were determined according to the method described above. The results are presented in Table 3.

TABLE 3

| | CompD | Ex4 | CompE | Ex5 | CompF | Ex6 |
|---|---|---|---|---|---|---|
| PC | 46 | 46 | 61 | 61 | 72 | 72 |
| ABS CompA | 53.5 | | 38.5 | | | 27.5 |
| ABS Ex2 | | 53.5 | | 38.5 | | 27.5 |
| E (MPa) | 2120 | 2100 | 2210 | 2190 | 2300 | 2320 |
| YS (MPa) | 45 | 45 | 48 | 47 | 55 | 56 |
| IM (kJ/m²) | 55 | 54 | 65 | 65 | 70 | 70 |
| Cycles | 20,000 | 62,000 | 18,500 | 58,000 | 19,000 | 57,000 |
| (66%) | | | | | | |
| Cycles | 12,000 | 39,000 | 11,000 | 35,500 | 11,500 | 34,000 |
| (75%) | | | | | | |

1. Polymer composition containing a semi-crystalline or glass-forming polymer in a rigid phase and, as impact modifier therein, a rubbery polymer, characterized in that the polymer composition has no morphological inhomogeneities with a diameter larger than 40, preferably 20 micrometer, as visible on a Scanning Electron Microscopy (SEM) picture of the surface of fracture of a test bar broken in a fatigue test.

2. Polymer composition according to claim 1, characterized in that the morphological inhomogeneities consist substantially of polymer material built up from building blocks of the surrounding polymer composition but having a composition deviating from the surrounding polymer composition.

3. Polymer composition according to claim 1, characterized in that morphological inhomogeneities mainly contain the rubbery polymer.

4. Polymer composition according to claims 1, characterized in that the polymer in the rigid phase has been chosen from the group of polycarbonates, polyesters, polyamides, or styrene polymers and the rubbery polymer has been chosen from the group of EPDM, EP, SEBS, SBR, PB, MBS or acrylate rubbers.

5. Polymer composition according to claim 4, characterized in that the rigid phase is polycarbonate and the impact modifier is ABS.

6. Process for the preparation of a polymer composition according to claim 1, characterized in that the polymer of the rigid phase and the rubbery polymer, which contain no morphological inhomogeneities with a diameter larger than 40, preferably 20 micrometer, are mixed.

7. Process for the preparation of a polymer composition according to claim 1, characterized in that the morphological inhomogeneities with a diameter larger than 40, preferably 20 micrometer are removed from the polymer of the rigid phase and/or the rubbery polymer before, during or after the mixing thereof.

8. Process according to claim 7, characterized in that the morphological inhomogeneities have been removed by filtration.

9. Polymer composition obtainable according to the process according to claim 6.

10. Polymer composition according to claim 1, containing polycarbonate and ABS, having a service life of at least 25,000 cycles.

11. Moulded articles containing a polymer composition according to claim 1.
